(19) United States
(12) Patent Application Publication
(10) Pub. No.: US 2010/0001092 A1
(43) Pub. Date: Jan. 7, 2010

(54) WATER FEATURE

(75) Inventor: Joseph Kloppenberg, Englewood, CO (US)

Correspondence Address: DORR, CARSON & BIRNEY, P.C.;ONE CHERRY CENTER, 501 SOUTH CHERRY STREET, SUITE 800, DENVER, CO, 80246, US

(73) Assignee: KLOPPENBERG & COMPANY, Englewood, CO (US)

(21) Appl. No.: 12/435,933

(22) Filed: May 5, 2009

Related U.S. Application Data
(60) Provisional application No. 61/078,587, filed on Jul. 7, 2008.

(51) Int. Cl. B05B 17/08

(52) U.S. Cl. 239/20

(57) ABSTRACT

A water feature provides both an ultraviolet light to kill micro-organisms circulating in the water stream, and an antimicrobial coating applied by powder coating to inhibit the growth of micro-organisms on the water-contacting surfaces of the water feature.

### RELATED APPLICATION

The present application is based on and claims priority to the Applicant's U.S. Provisional Patent Application 61/078,587, entitled “Water Feature,” filed on Jul. 7, 2008.

### BACKGROUND OF THE INVENTION

1. Field of the Invention

The present invention relates generally to the field of water features. More specifically, the present invention discloses a water feature having an ultraviolet light to kill micro-organisms in the water, and an antimicrobial coating to inhibit the growth of micro-organisms that is applied by powder coating to the surfaces of the water feature.

2. Statement of the Problem

Water features have been used for many years, primarily for aesthetic reasons. One common type of water feature includes a surface (e.g., a vertical metallic or translucent panel) for displaying a thin film of flowing water, a reservoir at the bottom of the surface to collect water, and a pump for recirculating water from the reservoir to the top of the surface. The water flowing down the surface not only has an aesthetic appeal, but also helps to remove dust, smoke, pollutants and micro-organisms from the surrounding room.

Unfortunately, many micro-organisms find the water and water-covered surfaces of a water feature to be a suitable habitat. The growth of micro-organisms in water features is not sanitary and can significantly decrease the aesthetic appeal of the water feature.

Therefore, a need exists for a means to effectively inhibit or prevent the growth of micro-organisms in water features. One approach to this problem has been to filter the water circulating in the water feature. This is helpful to some degree in trapping larger colonies of micro-organisms, but is less effective in trapping individual micro-organisms in the water stream or in preventing micro-organisms from spreading on the surfaces of the water feature.

Another approach has been to use ultraviolet light to kill micro-organisms. For example, U.S. Patent Application Publication 2002/0139865 (Mulvaney) discloses a water display with an ultraviolet light in its reservoir to kill micro-organisms. UV light has been effective in killing micro-organisms circulating in the water stream. However, it is generally impractical to design a water feature so that its water-contacting surfaces are effectively exposed to UV light, while maintaining a desired aesthetic appearance for the water feature. As a result, micro-organisms that do not circulate through the UV filter can continue to grow and spread on the surfaces of the water feature.

Solution to the Problem. The present invention addresses the shortcomings in the prior art in this field by combining ultraviolet light to kill micro-organisms circulating in the water, with an antimicrobial coating applied by powder coating to inhibit the growth of micro-organisms on the surfaces of the water feature. This combination has been shown to be far more effective in reducing the overall population levels of micro-organisms than either approach, by itself.

### SUMMARY OF THE INVENTION

This invention provides a water feature having both an ultraviolet light to kill micro-organisms circulating in the water stream, and an antimicrobial coating applied by powder coating to inhibit the growth of micro-organisms on the water-contacting surfaces of the water feature.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a front perspective view of a water feature.

FIG. 2 is a vertical cross-sectional view of a water feature.

FIG. 3 is a front perspective view of a water feature with a portion of the water feature cut away to show internal components used for water circulation.

FIG. 4 is a detail cross-sectional view of the upper reservoir assembly.

FIG. 4a is a detail cross-sectional view of a portion of the upper reservoir assembly.

### DETAILED DESCRIPTION OF THE INVENTION

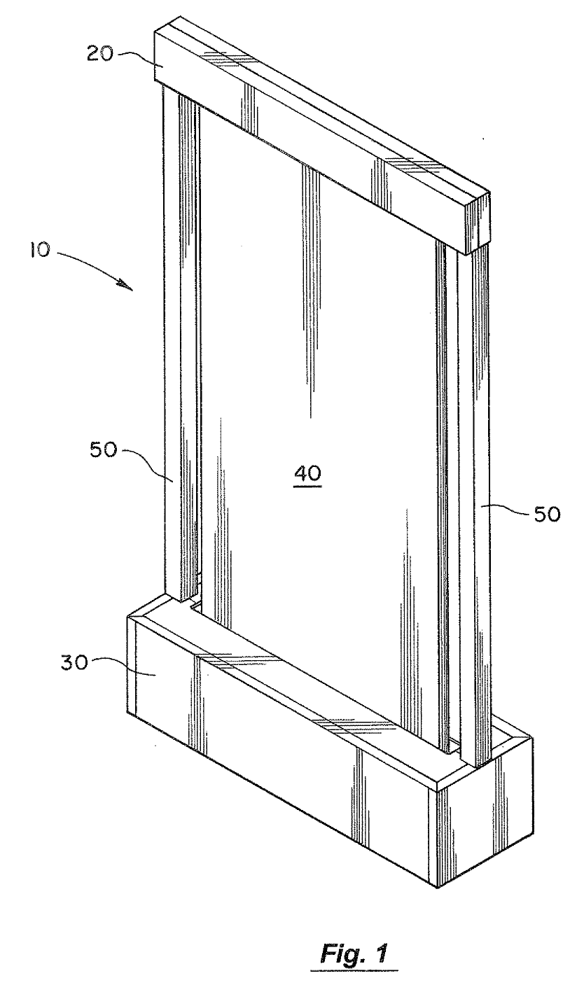

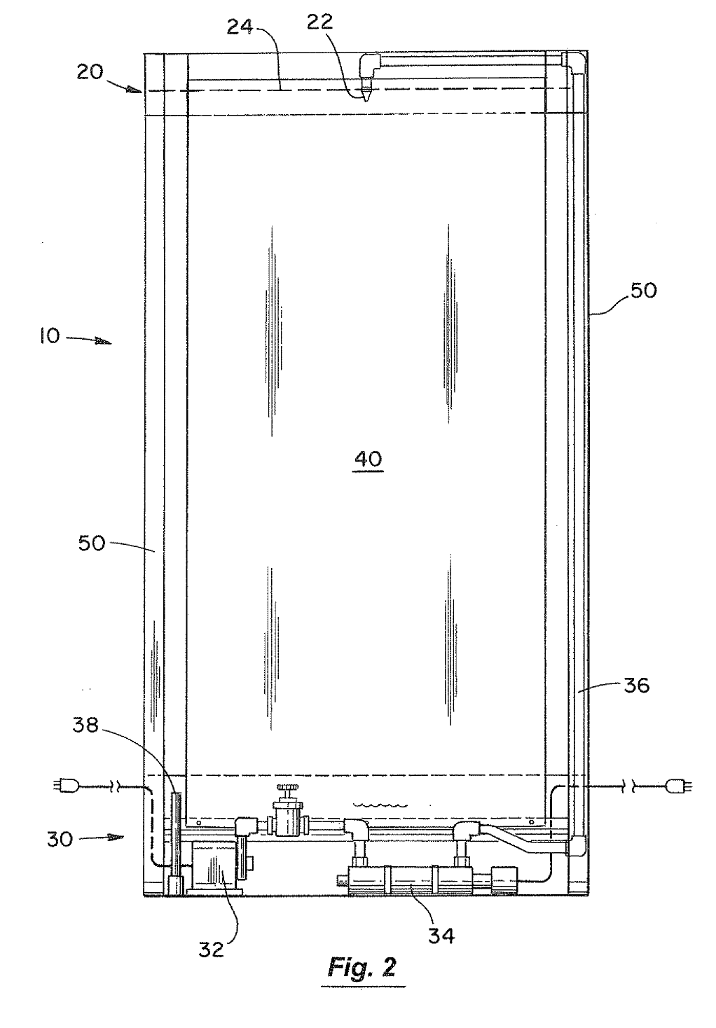

Turning to FIG. 1, a front perspective view is provided showing a water feature 10. The major components of a water feature 10 typically include an upper reservoir 20, a lower reservoir 30 and the waterfall sheet 40 extending vertically between these reservoirs 20, 30. FIG. 2 is a corresponding vertical cross-sectional view of this water feature. In this embodiment, the upper reservoir 20 is supported by two vertical supports 50 on either side of the waterfall sheet 50.

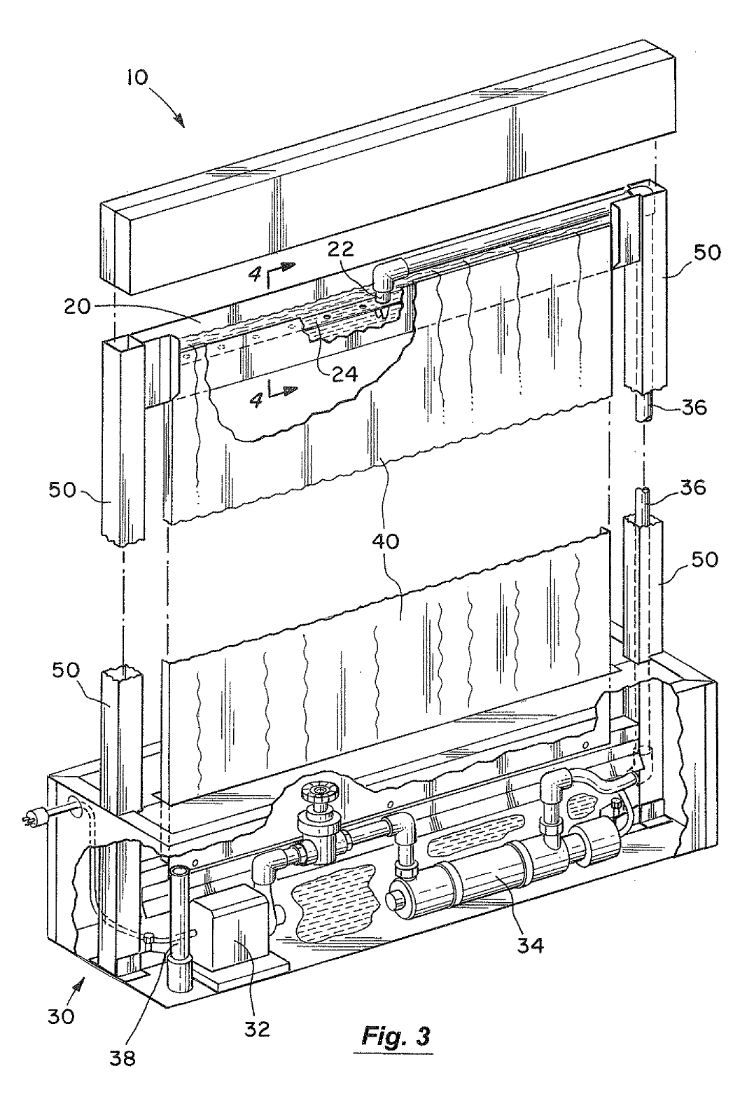

FIG. 3 is a front perspective view of a water feature with a portion of the water feature cut away to show internal components used for water circulation. In this embodiment, a pump 32 in the lower reservoir 30 is used to circulate water from the lower reservoir 30 into the upper reservoir 20. In particular, water can be pumped through a tube 36 concealed within one of the vertical supports 50. The water then flows from the upper reservoir 20 over the surface of the waterfall sheet 40 to create an aesthetically-pleasing effect and drains from the lower end of the waterfall sheet 40 back into the lower reservoir 30. Alternatively, the pump could be located elsewhere, such as within the upper reservoir 20 or one of the vertical supports 50. Optionally, the water can also be filtered as it is recirculated. A drain pipe 38 in the lower reservoir 30 prevents it from overflowing. In the event the water level in the lower reservoir 30 rises above the upper opening of the drain pipe, excess water escapes harmlessly down the drain pipe.

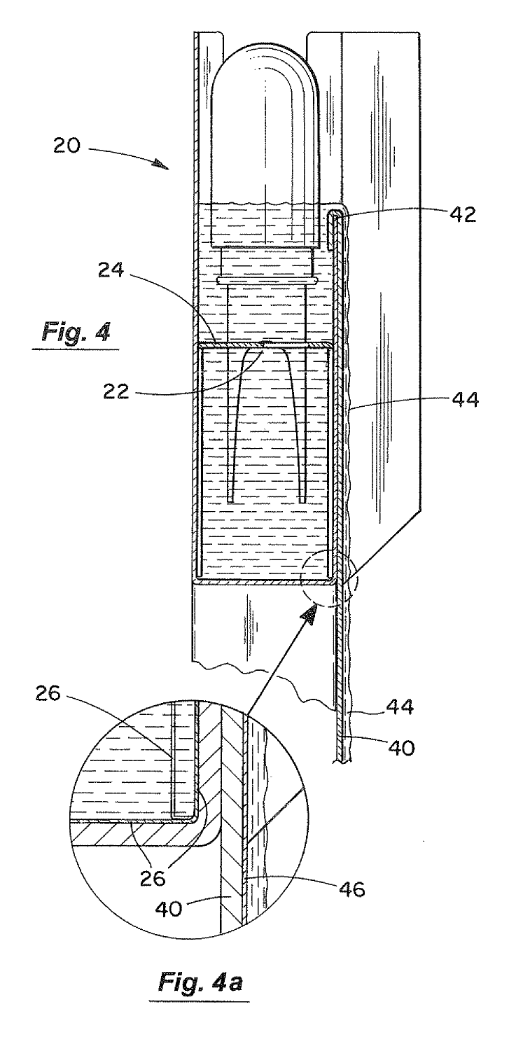

FIGS. 4 and 4a are detail cross-sectional views of the upper reservoir. Water is supplied by the tube 36 through an outlet 22 within the upper reservoir 20. A perforated, horizontal baffle 24 helps to maintain an even water level along the length of the upper reservoir 20. As shown in FIG. 4, the upper edge 42 of the waterfall sheet 40 creates a false edge along the front of the upper reservoir 20. This allows a thin sheet of water 44 to continuously flow over the edge and down the waterfall sheet 40 into the lower reservoir 30.

The present invention employs ultraviolet light to kill micro-organisms in the water circulating in the water feature 10. Ultraviolet light in the UV-C spectrum (approximately 100-280 nm wavelength) has the greatest germicidal effectiveness. In the embodiment depicted in FIGS. 2-3, an ultraviolet light 34 is located inside a housing (in the lower reservoir 30) through which the water is pumped. The housing is opaque to prevent ultraviolet radiation from escaping into the surrounding environment.

The second feature employed in the present invention to inhibit the growth of micro-organism is an antimicrobial coating on at least some of the surfaces of the water feature 10 that come into contact with water. Preferably, all of the water-contacting surfaces are treated with an antimicrobial coating. For example, antimicrobial coatings 26 and 46 are shown in the surfaces of the upper reservoir 20 and waterfall sheet 40 in FIG. 4a.

Any of a variety of antimicrobial powder coatings can be applied to the surfaces of the water feature. For example, metal surfaces of the water feature can be powder-coated with a silver-based inorganic material, such as the SANIGUARD material marketed by Component Hardware Group (CHG) of Lakewood, N.J. The SANIGUARD products utilize an inorganic silver ion technology, combined with a powder coating material to inhibit the growth of micro-organisms and prevent their survival on treated surfaces.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A water feature comprising:
a waterfall sheet having at least one water-contacting surface;
a reservoir containing water and having water-contacting surfaces, said reservoir being positioned so that water drains from the waterfall sheet into the reservoir;
a pump circulating water from the reservoir to the waterfall sheet so that water flows down the waterfall sheet and drains back into the reservoir;
a housing through which the water is circulated;
an ultraviolet light within the housing to kill microorganisms in the circulating water; and
an antimicrobial coating on the water-contacting surfaces of the reservoir and waterfall sheet to inhibit the growth of microorganisms.

2. The water feature of claim 1 wherein the ultraviolet light and housing are within the reservoir.

3. The water feature of claim 1 wherein the ultraviolet light is in the UV-C spectrum.

4. The water feature of claim 1 wherein the antimicrobial coating comprises a powder coating containing a silver-based inorganic material.

5. The water feature of claim 1 wherein the housing is opaque.

6. A water feature comprising:
a lower reservoir containing water and having water-contacting surfaces;
an upper reservoir containing water and having water-contacting surfaces;
a waterfall sheet extending vertically between the upper and lower reservoirs so that water from the upper reservoir flows down the waterfall sheet and drains into the lower reservoir, said waterfall sheet having at least one water-contacting surface;
a pump circulating water from the lower reservoir into the upper reservoir;
an opaque housing through which the water is circulated;
an ultraviolet light within the housing to kill microorganisms in the circulating water; and
an antimicrobial powder coating containing a silver-based inorganic material on the water-contacting surfaces of the upper and lower reservoirs and waterfall sheet to inhibit the growth of microorganisms.

7. The water feature of claim 6 wherein the ultraviolet light and housing are within the reservoir.

8. The water feature of claim 6 wherein the ultraviolet light is in the UV-C spectrum.
